(19) United States
(12) Patent Application Publication
(10) Pub. No.: US 2025/0203294 A1
(43) Pub. Date: Jun. 19, 2025

(54) Speaker and Electronic Device Using Same

(71) Applicant: AAC Microtech (Changzhou) Co., Ltd., Changzhou (CN)

(72) Inventor: Chao Zhang, Changzhou (CN)

(21) Appl. No.: 18/645,414

(22) Filed: Apr. 25, 2024

Related U.S. Application Data
(63) Continuation of application No. PCT/CN2023/139650, filed on Dec. 18, 2023.

(51) Int. Cl. H04R 9/04; H04R 7/12; H04R 9/06

(52) U.S. Cl. CPC H04R 9/045; H04R 7/127; H04R 9/046; H04R 9/06; H04R 2207/021

(57) ABSTRACT

A speaker and an electronic device using the speaker are disclosed. The speaker includes a frame with a receiving cavity, and a vibration system and a magnetic circuit system that are contained in the receiving cavity. The vibration system includes a diaphragm assembly and a voice coil. The voice coil includes a coil body and a lead wire extending from the coil body. The diaphragm assembly includes a main body and an avoiding part formed by bending from the main body and in a direction far away from the voice coil. The coil body is bonded with the main body and forms an avoiding space together with the avoiding part. The lead wire passes through the avoiding space to electrically connect with an external power supply. The speaker and the electronic device can have a miniaturized overall size and a better reliability.

### TECHNICAL FIELD

The present disclosure relates to an electro-acoustic transducer, in particular to a speaker and an electronic device using the speaker.

### BACKGROUND

Speakers, as essential components of portable electronic devices, are widely used in various portable electronic devices, such as cell phones, tablet computers, portable game consoles, and so on. In a traditional speaker, of which a vibration system includes a voice coil and a diaphragm assembly, the voice coil and the diaphragm assembly are glued together so as to use the voice coil to drive the diaphragm assembly for vibrating and producing sounds.

However, the traditional speaker does not have a crossing structure for a lead wire of the voice coil passing though, the lead wire is directly sandwiched between the voice coil and the diaphragm assembly, which makes the voice coil and the diaphragm assembly need a larger space therebetween in a vibration direction of the diaphragm assembly for the lead wire, resulting in an excessive overall size of the traditional speaker, and also is likely to affect the gluing effect between the voice coil and the diaphragm assembly, resulting in a weak reliability of the traditional speaker.

Therefore, it is necessary to provide a novel speaker to solve the above problems.

### SUMMARY

In view of the above, an objective of the present disclosure is to provide a speaker and an electronic device using the speaker, that can have a miniaturized overall size and a better reliability.

In order to achieve the objective mentioned above, the present disclosure discloses a speaker including a frame with a receiving cavity, and a vibration system and a magnetic circuit system that are contained in the receiving cavity. The vibration system includes a diaphragm assembly and a voice coil. The voice coil includes a coil body and a lead wire extending from the coil body. The diaphragm assembly includes a main body and an avoiding part formed by bending from the main body and in a direction far away from the voice coil. The coil body is bonded with the main body and forms an avoiding space together with the avoiding part. The lead wire passes through the avoiding space to electrically connect with an external power supply.

In some embodiments, an amount of the avoiding parts is two, each avoiding part forms a corresponding avoiding space together with the coil body. The lead wire includes a first wire and a second wire, the first wire and the second wire each passes through a corresponding avoiding space. One of the first wire and the second wire is used for electrically connecting with a positive pole of the external power supply, and the other is used for electrically connecting with a negative pole of the external power supply.

In some embodiments, the two avoiding parts are arranged symmetrically with respect to a center point of the main body.

In some embodiments, the coil body includes two first edges opposite to each other and two second edges connecting the two first edges. An edge length of the two first edges is greater than that of the two second edges. Each avoiding part is arranged at a corresponding position of the main body corresponding to a junction of the adjacent first edge and second edge.

In some embodiments, the avoiding part includes a side wall extending from the main body and in the direction far away from the voice coil, and an end wall disposed at an end of the side wall far away from the voice coil. An orthographic projection of the end wall to the voice coil includes a part located at an inner side of the voice coil and another part located at an outer side of the voice coil.

In some embodiments, an area of the part of the orthographic projection located at the inner side of the voice coil is greater than that of the another part of the orthographic projection located at the outer side of the voice coil.

In some embodiments, the main body includes a diaphragm fixed to the frame and a dome attached to the diaphragm, the avoiding part is formed on the dome.

In some embodiments, the dome is bonded with the diaphragm.

In some embodiments, the diaphragm includes a suspension in a ring shape, a first end portion extending from an inner edge of the suspension, and a second end portion extending from an outer edge of the suspension. At least part of the first end portion overlaps with the dome in a vibration direction of the diaphragm assembly and is bonded with the dome.

In another aspect, the present disclosure also discloses an electronic device using the speaker mentioned above.

In the speaker and the electronic device according to the present disclosure, since the diaphragm assembly includes the avoiding part formed by bending from the main body and in the direction far away from the voice coil, and further the coil body is bonded with the main body and forms the avoiding space together with the avoiding part, the lead wire can pass through the avoiding space to electrically connect with the external power supply, which makes the coil body can be bonded with the main body directly for saving the traditional space between the coil body and the main body for the lead wire, thereby miniaturizing the overall size of the speaker and the electronic device. In addition, since the coil body can be bonded with the main body directly, the lead wire does not affect the bonding effect between the coil body and the main body, thus, the coil body can be bonded with the main body firmly for improving the reliability of the speaker and the electronic device.

### BRIEF DESCRIPTION OF DRAWINGS

FIG. 1 is an isometric view of a speaker in accordance with an exemplary embodiment of the present disclosure;

FIG. 2 is a cross-sectional view of the speaker in FIG. 1;

FIG. 3 is an enlarged view of part A in FIG. 2;

FIG. 4 is an isometric view of an assembly of a voice coil and a diaphragm assembly of the speaker in FIG. 1;

FIG. 5 is an enlarged view of part B in FIG. 4.

### DESCRIPTION OF EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

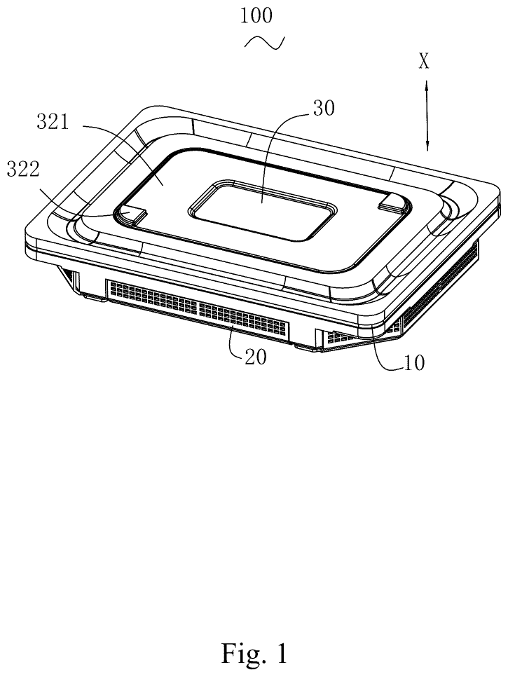

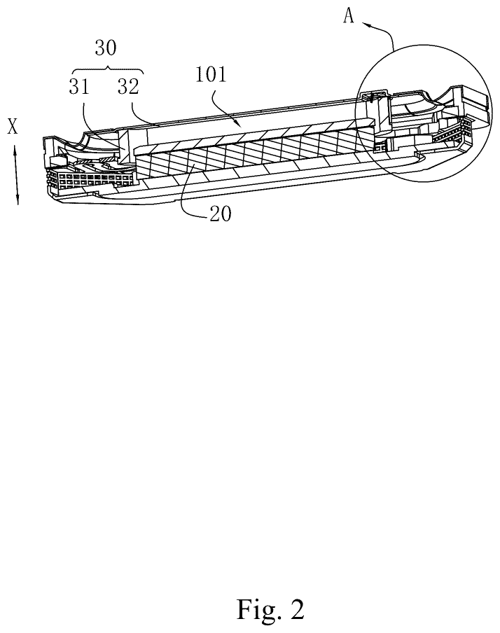

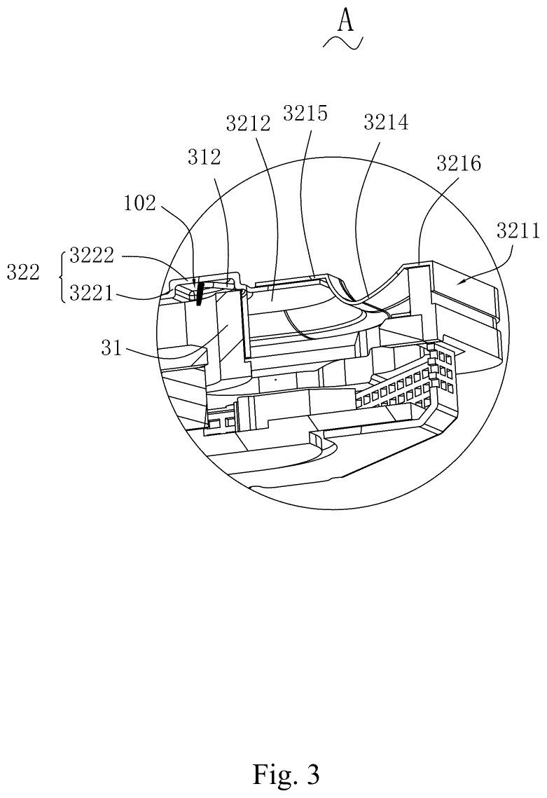

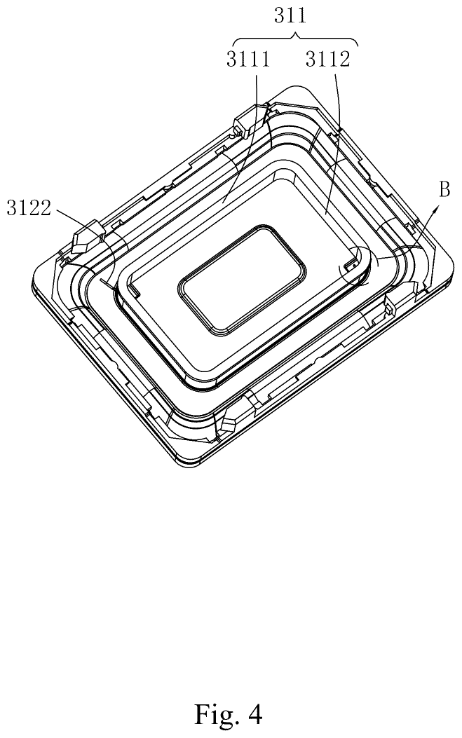

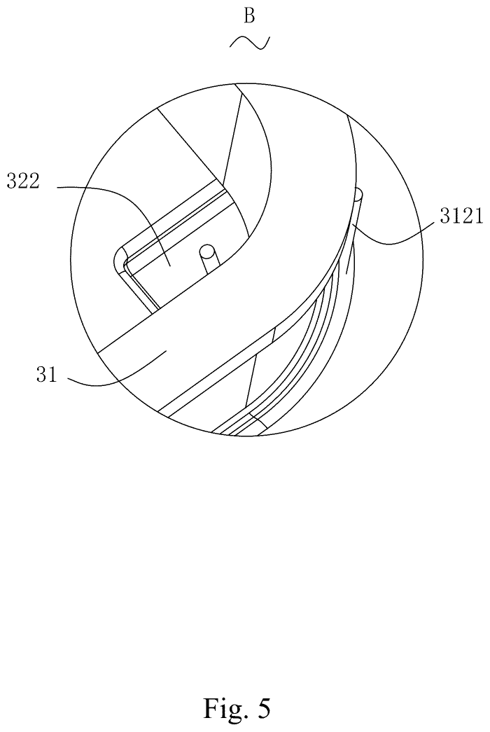

As shown in FIGS. 1-5, the present disclosure discloses a speaker 100 including a frame 10 with a receiving cavity 101, and a magnetic circuit system 20 and a vibration system 30 that are contained in the receiving cavity 101.

The frame 10 is used for fixing and supporting the magnetic circuit system 20 and the vibration system 30 for providing a stable and sealed work environment for the magnetic circuit system 20 and the vibration system 30.

In some embodiments, the frame 10 is a sealed enclosure so as to use the enclosure to form the receiving cavity 101 in which the whole of the magnetic circuit system 20 and the vibration system 30 is contained. In some embodiments, the frame 10 is a ring with two end openings, a part of the magnetic circuit system 20 blocks one end opening, and a part of the vibration system 30 blocks another end opening, namely, the frame 10, the magnetic circuit system 20 and the vibration system 30 together form the receiving cavity 101 in which the parts of the magnetic circuit system 20 and the vibration system 30 used for electromagnetically interacting with each other are contained.

The vibration system 30 includes a voice coil 31 and a diaphragm assembly 32. The voice coil 31 includes a coil body 311 and a lead wire 312 extending from the coil body 311. The voice coil 31 is actually formed by winding a conductor along a certain trajectory and becomes magnetic when energized, then vibrates in a magnetic gap of the magnetic circuit system 20. In these embodiments, the coil body 311 is formed by winding the conductor, the lead wire 312 is end segments of the conductor for electrically connecting with an external power supply.

The diaphragm assembly 32 includes a main body 321 and an avoiding part 322 formed by bending from the main body 321 and in a direction far away from the voice coil 31. The main body 321 connects with the voice coil 31 and is used for vibrating and producing sounds under the drive of the voice coil 31.

In some embodiments, in a forming process of the diaphragm assembly 32, the main body 321 is formed in a flat shape first, and then the avoiding part 322 is formed by stamping the main body 321. One side of the avoiding part 322 in a thickness direction of the main body 321 is a hollow, and the other side of the avoiding part 322 in the thickness direction of the main body 321 protrudes from the main body 321. In some embodiments, the diaphragm assembly 32 is formed by injection molding, which makes the main body 321 and the avoiding part 322 be integrally formed.

The coil body 311 is bonded with the main body 321 and forms an avoiding space 102 together with the avoiding part 322. At least part of the coil body 311 overlaps with the avoiding part 322 in a vibration direction X of the diaphragm assembly 32. The lead wire 312 can pass from an inner side of the coil body 311 to an outer side of the coil body 311 through the avoiding space 102, which prevents the lead wire 312 from being sandwiched between the coil body 311 and the main body 321, so as to save the traditional space between the coil body 311 and the main body 321 for the lead wire 312, thereby miniaturizing the overall size of the speaker 100.

In some embodiments, an amount of the avoiding parts 322 is two, each avoiding part 322 forms a corresponding avoiding space 102 together with the coil body 311. The lead wire 312 includes a first wire 3121 and a second wire 3122, the first wire 3121 and the second wire 3122 each passes through a corresponding avoiding space 102. One of the first wire 3121 and the second wire 3122 is used for electrically connecting with a positive pole of the external power supply, and the other is used for electrically connecting with a negative pole of the external power supply.

The first wire 3121 and the second wire 3122 are two end segments of the wound conductor forming the coil body 311. In one situation that the first wire 3121 is close to the second wire 3122, the first wire 3121 and the second wire 3122 can pass through the same avoiding space 102, in another situation that the first wire 3121 is far away from the second wire 3122, the first wire 3121 and the second wire 3122 can respectively pass through a corresponding avoiding space 102.

One of the first wire 3121 and the second wire 3122 is used for electrically connecting with a positive pole of the external power supply, and the other is used for electrically connecting with a negative pole of the external power supply, so as to form a current path in the coil body 311.

In some embodiments, the two avoiding parts 322 are arranged symmetrically with respect to a center point of the main body 321. The center point can be a geometric center or a gravity center of the main body 321. In this situation, the two avoiding parts 322 can adapt to the farthest position between the first wire 3121 and the second wire 3122.

Optionally, the main body 321 has a rectangle shape, the two avoiding parts 322 can be arranged at two length or width sides of the main body 321.

In some embodiments, the coil body 311 includes two first edges 3111 opposite to each other and two second edges 3112 connecting the two first edges 3111. An edge length of the two first edges 3111 is greater than that of the two second edges 3112. The coil body 311 can be formed in a rectangle ring by winding the conductor, the two first edges 3111 are the length sides of the rectangle ring, and the two second edges 3112 are width sides of the rectangle ring.

The avoiding part 322 is arranged at a corresponding position of the main body 321 corresponding to a junction of the adjacent first edge 3111 and second edge 3112, namely, the avoiding part 322 is arranged at a corner of the main body 321. Even though the side of the avoiding part 322 close to the coil body 311 is a hollow where can not be bonded with the diaphragm assembly 32, the corner can provide a support for the avoiding part 322 for improving the connection stability between the coil body 311 and the main body 321 and further improving the reliability of the speaker 100.

In some embodiments, the avoiding part 322 includes a side wall 3221 extending from the main body 321 and in the direction far away from the voice coil 31, and an end wall 3222 disposed at an end of the side wall 3221 far away from the voice coil 31. An orthographic projection of the end wall 3222 to the voice coil 31 includes a part located at an inner side of the voice coil 31 and another part located at an outer side of the voice coil 31.

It should be noted that, the orthographic projection of the end wall 3222 to the voice coil 31 is projected along the vibration direction X of the diaphragm assembly 32. The inner side of the voice coil 31 is a side of the voice coil 31 far away from the frame 10, and the outer side of the voice coil 31 is a side of the voice coil 31 close to the frame 10.

Since the orthographic projection of the end wall 3222 to the voice coil 31 includes a part located at an inner side of the voice coil 31 and another part located at an outer side of the voice coil 31, the avoiding space 102 can communicate spaces of the voice coil 31 far away from and close to the frame 10, so that the lead wire 312 can pass from the space of the coil body 311 far away from the frame 10 to the space of the coil body 311 close to the frame 10 through the avoiding space 102.

In some embodiments, an area of the part of the orthographic projection located at the inner side of the voice coil 31 is greater than that of the another part of the orthographic projection located at the outer side of the voice coil 31, which is aimed to reduce a size of an opening of the avoiding space 102 communicating with the outer space of the voice coil 31, and then to improve the sealed environment of the inner space of the voice coil 31 for preventing the external dust from entering into the inner space of the voice coil 31 for a better acoustic performance.

In some embodiments, the main body 321 includes a diaphragm 3211 fixed to the frame 10 and a dome 3212 attached to the diaphragm 3211. The avoiding part 322 is formed on the dome 3212.

The diaphragm 3211 and the dome 3212 can be in one piece, the diaphragm 3211 and the dome 3212 are integrally formed. The diaphragm 3211 and the dome 3212 can also be separate, the diaphragm 3211 and the dome 3212 are respectively formed and then bonded together. The frame 10 supports the main body 321 through the diaphragm 3211 being fixed to the frame 10. The dome 3212 connects with the voice coil 31 and vibrates and produces sounds under the drive of the voice coil 31.

In some embodiments, the diaphragm 3211 includes a suspension 3214 in a ring shape, a first end portion 3215 extending from an inner edge of the suspension 3214, and a second end portion 3216 extending from an outer edge of the suspension 3214. At least part of the first end portion 3215 overlaps with the dome 3212 in the vibration direction X of the diaphragm assembly 32 and is bonded with the dome 3212.

The second end portion 3216 is fixed to the frame 10 for making the diaphragm assembly 32 be supported by the frame 10. At least part of the first end portion 3215 overlaps with the dome 3212 in the vibration direction X for making the first end portion 3215 be bonded with the dome 3212. The suspension 3214 is used for reducing the horizontal vibration of the dome 3212 and supporting the vertical vibration of the dome 3212 for obtaining a better acoustic performance when the diaphragm assembly 32 vibrates and produces sounds.

In another aspect, the present disclosure also discloses an electronic device using the speaker 100. The electronic device can be, but not limited to, a cell phone, a tablet computer, a speaker box, a headset or a display.

In the speaker 100 and the electronic device according to the present disclosure, since the diaphragm assembly 32 includes the avoiding part 322 formed by bending from the main body 321 and in the direction far away from the voice coil 31, and further the coil body 311 is bonded with the main body 321 and forms the avoiding space 102 together with the avoiding part 322, the lead wire 312 can pass through the avoiding space 102 to electrically connect with the external power supply, which makes the coil body 311 can be bonded with the main body 321 directly for saving the traditional space between the coil body 311 and the main body 321 for the lead wire 312, thereby miniaturizing the overall size of the speaker 100 and the electronic device. In addition, since the coil body 311 can be bonded with the main body 321 directly, the lead wire 312 does not affect the bonding effect between the coil body 311 and the main body 321, thus, the coil body 311 can be bonded with the main body 321 firmly for improving the reliability of the speaker 100 and the electronic device.

The above descriptions are merely some of the embodiments of the present disclosure. It should be pointed out that for those of ordinary skill in the art, improvements can be made without departing from the inventive concept of the present disclosure, shall fall within the scope of the present disclosure.

What is claimed is:

1. A speaker, comprising:
a frame with a receiving cavity,
a vibration system contained in the receiving cavity, comprising a diaphragm assembly and a voice coil, and
a magnetic circuit system contained in the receiving cavity, wherein
the voice coil comprises a coil body and a lead wire extending from the coil body, the diaphragm assembly comprises a main body and an avoiding part formed by bending from the main body and in a direction far away from the voice coil, the coil body is bonded with the main body and forms an avoiding space together with the avoiding part, the lead wire passes through the avoiding space to electrically connect with an external power supply.

2. The speaker described as claim 1, wherein an amount of the avoiding parts is two, each avoiding part forms a corresponding avoiding space together with the coil body, the lead wire comprises a first wire and a second wire, the first wire and the second wire each passes through a corresponding avoiding space, one of the first wire and the second wire is used for electrically connecting with a positive pole of the external power supply, and the other is used for electrically connecting with a negative pole of the external power supply.

3. The speaker described as claim 2, wherein the two avoiding parts are arranged symmetrically with respect to a center point of the main body.

4. The speaker described as claim 3, wherein the coil body comprises two first edges opposite to each other and two second edges connecting the two first edges, an edge length of the two first edges is greater than that of the two second edges, each avoiding part is arranged at a corresponding position of the main body corresponding to a junction of the adjacent first edge and second edge.

5. The speaker described as claim 1, wherein the avoiding part comprises a side wall extending from the main body and in the direction far away from the voice coil, and an end wall disposed at an end of the side wall far away from the voice coil, an orthographic projection of the end wall to the voice coil comprises a part located at an inner side of the voice coil and another part located at an outer side of the voice coil.

6. The speaker described as claim 5, wherein an area of the part of the orthographic projection located at the inner side of the voice coil is greater than that of the another part of the orthographic projection located at the outer side of the voice coil.

7. The speaker described as claim 1, wherein the main body comprises a diaphragm fixed to the frame and a dome attached to the diaphragm, the avoiding part is formed on the dome.

8. The speaker described as claim 7, wherein the dome is bonded with the diaphragm.

9. The speaker described as claim 8, wherein the diaphragm comprises a suspension in a ring shape, a first end portion extending from an inner edge of the suspension, and a second end portion extending from an outer edge of the suspension, at least part of the first end portion overlaps with the dome in a vibration direction of the diaphragm assembly and is bonded with the dome.

10. An electronic device, comprising the speaker as described in claim 1.
